(19) United States
(12) Patent Application Publication
(10) Pub. No.: US 2006/0045599 A1
(43) Pub. Date: Mar. 2, 2006

(54) Customizable keyboard that can be fitted with detachable keys in various shapes and sizes

(76) Inventor: Yandi Ongkojoyo, Quincy, MA (US)

Correspondence Address: YANDI ONGKOJOYO, DHARMAHUSADA PERMAI XII/9 N-405, SURABAYA, EAST JAVA, 60116, ID

(21) Appl. No.: 10/929,937

(22) Filed: Aug. 30, 2004

(51) Int. Cl. B41J 5/12

(52) U.S. Cl. 400/483

(57) ABSTRACT

Customizable keyboard that can be fitted/affixed with detachable keys in various shapes and sizes. The customizable keyboard system may comprise a programmable keyboard controller, keyboard keys with interlocking and/or stacking mechanism, and detachable keyboard keys in various shapes and sizes. The detachable keys may support interlocking or stacking mechanisms. The customizable keyboard system may also comprise keyboard sockets or ports for connection to other keyboards, input/output ports for programming the keyboard controller, interlocking mechanisms, and connector systems and/or protocols to connect several keyboards to work together.

### CROSS-REFERENCE TO RELATED APPLICATIONS

Not applicable.

### BACKGROUND

1. Field of the Invention

This invention relates generally to keyboard, specifically to a customizable keyboard.

2. Description of Prior Art

Regular keyboard has a fixed set of keys and/or size and/or a fixed structure, and each key has a fixed shape and/or size and/or appearance that relates to a specific character and/or control. For some users using regular keyboard is inconvenient, difficult, and even impossible because of its size, structure, shape, or appearance. For some others users, regular keyboard is not very stimulating or even boring, and sometimes doesn't accommodate their special needs for special key configuration.

### SUMMARY OF THE INVENTION

The primary object of the invention is to provide a system that allows users to attach keys in various shapes, sizes, and appearances to their keyboard or keyboard keys.

Another object of the invention is to create a programmable keyboard, in which each key can be programmed to relate to any character and/or control and/or action. Another object of the invention is to create a customizable keyboard that can be attached to a computer independently or in addition to one or more regular and/or customizable keyboards, or serves as a master to other regular and/or customizable keyboards so the customizable keyboard can be used together with other keyboards.

Another object of the invention is to create detachable keyboard keys in various shapes and sizes that can be interlocked and/or stacked with each other.

Another object of the invention is to create keyboard keys which surface or surfaces can be customized with sticker, paint, or other means to alter their appearances.

Another object of the invention is to create customizable keyboards that can be attached to each other to work as one keyboard.

Another object of the invention is to create customizable keyboards that can be attached and/or connected to other input devices comprising joystick and/or tracking ball.

In accordance with the invention, a system comprises a customizable keyboard with keys that can be fitted with detachable keys in various shapes and sizes that can be interlocked and/or stacked with or on each other. The keyboard can be used alone, connected with a special adapter in addition to a regular keyboard, or used as a master to a regular keyboard that can be connected to it.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention. The foregoing features and other aspects of this invention will now be described in accordance with the drawings in which:

FIG. 1 shows various ways to fit/affix a customizable keyboard with detachable keys, various ways to interlock and/or stack keys with or on each other, and various ways to customize the appearance of the keys.

FIG. 2 shows a way to connect the customizable keyboard to a computer system as the only active keyboard.

FIG. 3 shows a way to connect the customizable keyboard in addition to a regular keyboard to a computer system using an adapter.

FIG. 4 shows a way to connect the customizable keyboard as a master keyboard in a master-slave configuration to a computer system.

FIG. 5 shows a way to join or attach two or more keyboards with interlocking mechanisms and a way to connect two or more customizable keyboards, and electively a regular keyboard, to a computer system.

FIG. 6 shows a way to join or attach two or more customizable keyboards with interlocking mechanisms.

### DETAILED DESCRIPTIONS OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

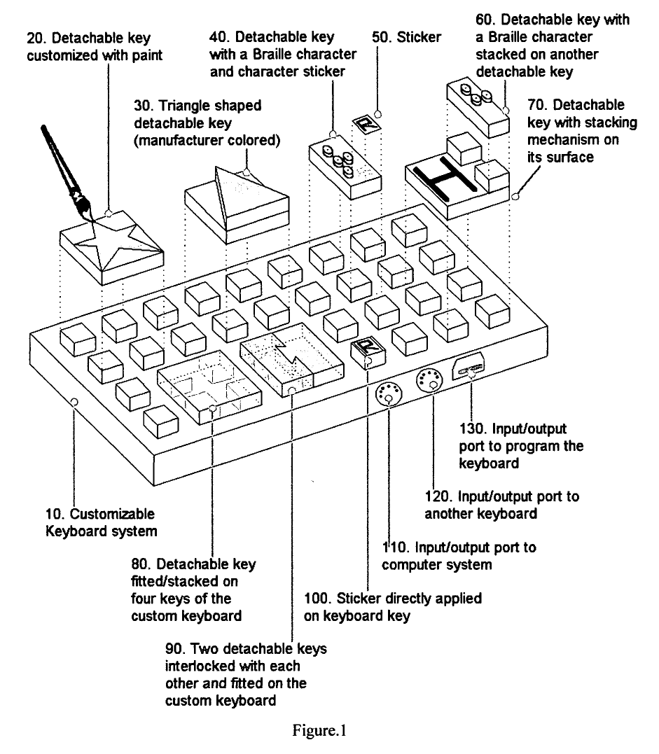

Referring now to FIG. 1, The customizable keyboard system comprises a customizable keyboard (10), detachable keys in Various shapes and sizes, and input/output ports. The keyboard keys and/or the detachable keys can be customized by painting it (20), sticking stickers on it (40, 50, 100), and/or attaching one or more detachable key to them (60,70,80,90). Detachable keys can be made according to user's needs, comprising larger detachable keys (20,30,80), detachable keys with various shapes (20,30), detachable keys with Braille characters (40,60). Detachable keys with interlocking mechanism can be attached with each other (90) or on each other (60,70). The customizable keyboard can be connected to a computer system through an input output port (110). The customizable keyboard can also be connected through an input output port (120) to a regular keyboard or another customizable keyboard in a master-slave configuration. The customizable keyboard can be programmed to respond in a specific way to each key pressed through an input output port (130).

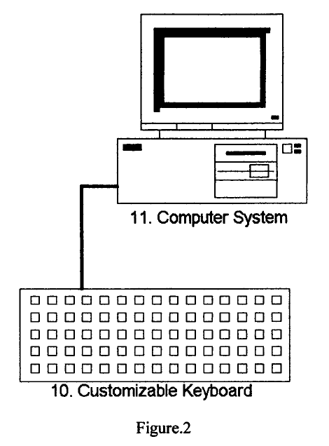

Referring now to FIG. 2, user can connect the customizable keyboard (10) to a computer system (11) without adding a regular keyboard.

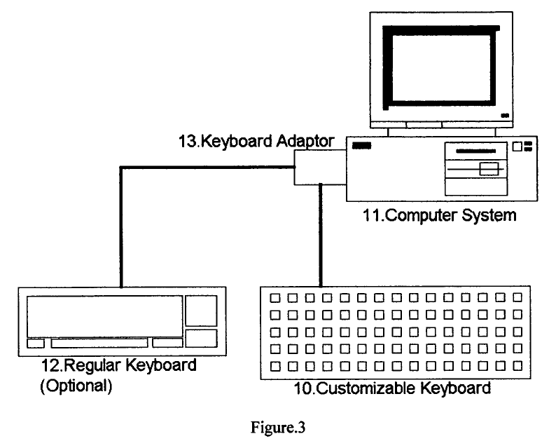

Referring now to FIG. 3, user can connect the customizable keyboard (10) to a computer system (11). User can electively install a regular keyboard (12) to the computer system (11) in addition to the customizable keyboard (10), using a keyboard adaptor (13).

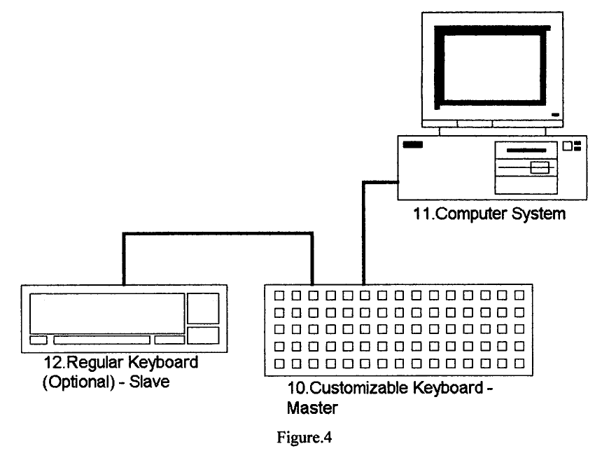

Referring now to FIG. 4, user can connect the customizable keyboard (10) to a computer system (11). User can electively connect a regular keyboard (12) to the customizable keyboard in a master-slave configuration.

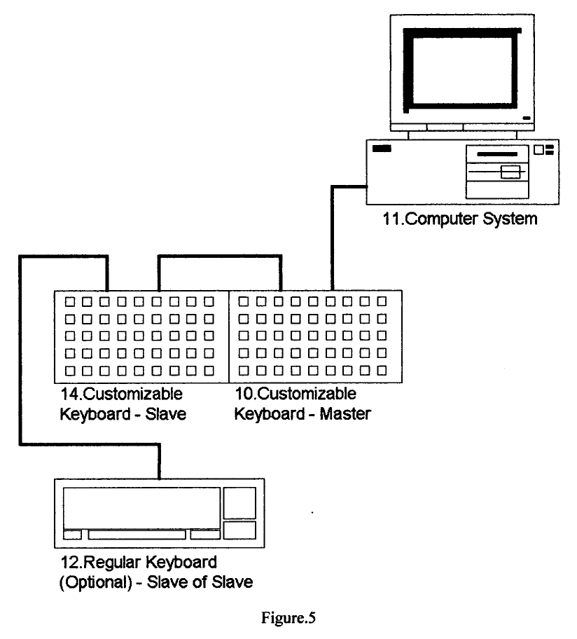

Referring now to FIG. 5, user can attach and connect several customizable keyboards (10, 14) to each other and connect them to the computer system (11). User can electively connect a regular keyboard (12) to the customizable keyboard in a master-slave configuration.

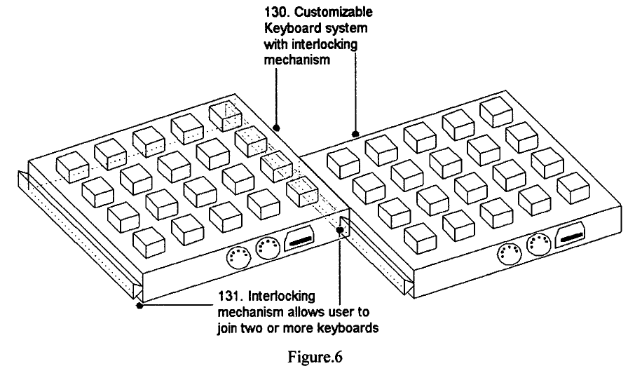

Referring now to FIG. 6, user can attach several customizable keyboards (130) to each other using interlocking mechanisms (131).

What is claimed is:

1. A customizable keyboard system that can be fitted/affixed with detachable keys in various sizes and shapes.

2. Detachable keyboard keys in various sizes and shapes.

3. A programmable keyboard, in which users can program each key to relate to a specific character and/or action and/or control.

4. The system of claim 1 wherein further comprising means to attach and/or interlock multiple keyboards.

5. The system of claim 1 wherein further comprising means to allow multiple keyboards to work together.

6. The system of claim 1 wherein further comprising other input devices comprising joystick and/or tracking ball.

7. The device of claim 2 wherein further comprising means to interlock the detachable keys to each other and/or to stack them on each other.

8. The device of claim 2 wherein further comprising means to alter the appearance of the detachable keys.

9. The device of claim 2 wherein further comprising the imprints of other characters comprising Braille, foreign characters, and/or large prints.

10. The device of claim 2 wherein further comprising means to alter regular keyboard to accommodate detachable keys.

11. The device of claim 3 wherein further comprising means to allow multiple keyboards to work together.
